(19) United States
(12) Patent Application Publication
(10) Pub. No.: US 2012/0328234 A1
(43) Pub. Date: Dec. 27, 2012

(54) Low-loss Optical Coupling Apparatus

(75) Inventors: Hung-Chih Lu, Taoyuan County (TW); Jen-Inn Chyi, Taoyuan County (TW)

(73) Assignee: NATIONAL CENTRAL UNIVERSITY, Taoyuan County (TW)

(21) Appl. No.: 13/293,228

(22) Filed: Nov. 10, 2011

(30) Foreign Application Priority Data
Jun. 24, 2011 (TW) 100122100

(51) Int. Cl. G02B 6/125

(52) U.S. Cl. 385/14

(57) ABSTRACT

A low-loss optical coupling apparatus includes a silicon-on-insulator wafer, a silicon dioxide layer, a taper waveguide, a channel waveguide and a thick-film silicon dioxide layer. The silicon-on-insulator wafer is formed with a silicon substrate. The silicon dioxide layer is provided on the silicon substrate. The taper waveguide comprises a slab region formed on the silicon dioxide layer and a waveguide region formed on the slab region. An end of a chip is connected to an end of the waveguide region. The channel waveguide is formed on the slab region and connected to another end of the waveguide region. The thick-film silicon dioxide layer extends on the taper waveguide and covers the entire waveguide region.

### TECHNICAL FIELD OF THE INVENTION

The present invention relates to an optical coupling apparatus; more particularly, relates to a low-loss optical coupling apparatus for use in optical coupling between chips.

### DESCRIPTION OF THE RELATED ARTS

A chip for optical coupling is made on a silicon-on-insulator wafer and integrated in a system-on-chip. A width of a silicon channel waveguide is smaller than 1 micron and a diameter of an optical fiber is about 2 microns, no matter the optical fiber is a tip-fiber or a photonic crystal fiber (PCF). Hence, there is considerable loss in optical coupling.

Conventionally, a grating is made on a taper silicon waveguide. Advancement of an input optical field is perpendicular to the surface of the chip. By the grating, the advancement of light is turned to the right angle before the light is coupled to the taper silicon waveguide. This conventional approach is suitable for optical coupling between a vertical cavity surface emitting laser (VCSEL) chip and a silicon optical chip; however, it is ineffective for optical coupling between an optical fiber and a silicon optical chip. For optical coupling between chips, not only the optical coupling between the optical chip and the VCSEL matters, but the optical coupling between the optical fiber and the chip also matters. Conventionally, the grating is used where the optical fiber extends perpendicularly to the surface of the chip and the taper silicon waveguide becomes hard to be packaged and is expensive.

The best optical coupling between the optical fiber and the chip ever is the conventional one used in optical communication chips, i.e. lateral optical coupling. In a conventional optical communication chip, the size of a waveguide is several microns and matches with a diameter of an optical fiber. Hence, there is limited loss in the optical coupling. However, there is considerable loss in the optical coupling since the width of the silicon optical waveguide is smaller than 1 micron while the diameter of the optical fiber is 2 microns.

Hence, the prior arts do not fulfill all users' requests on actual use.

### SUMMARY OF THE INVENTION

The main purpose of the present invention is to provide a low-loss optical coupling apparatus, which enhances conventional lateral optical coupling for greatly reducing optical loss in a small-core waveguide of a chip.

To achieve the above purpose, the present invention is a low-loss optical coupling apparatus, comprising a silicon-on-insulator wafer, a silicon dioxide layer, a taper waveguide, a channel waveguide and a thick-film silicon dioxide layer, where the silicon-on-insulator wafer is formed with a silicon substrate; the silicon dioxide layer is provided on the silicon substrate; the waveguide layer which is a silicon layer is provided on the silicon dioxide layer; the waveguide circuit is formed on the waveguide layer which comprises a slab region and a waveguide region; the taper waveguide of waveguide circuit is a waveguide which has one larger-width end and one smaller-width end; an end of a chip is connected to an end of the waveguide region; the channel waveguide of waveguide circuit is connected to the smaller-width end of the taper waveguide; and the thick-film silicon dioxide layer covers the entire taper waveguide.

In a preferred embodiment, the channel waveguide is a single-mode channel optical waveguide.

In another preferred embodiment, the taper waveguide has an end in flush with an end of the thick-film silicon dioxide layer.

In another preferred embodiment, the taper waveguide is completely covered by the thick-film silicon dioxide layer.

In another preferred embodiment, the low-loss optical coupling apparatus further has a polymer layer formed on the waveguide region.

In another preferred embodiment, the polymer layer is made of silicon nitride, photo-resist or polymer.

In another preferred embodiment, the low-loss optical coupling apparatus further has a grating formed on the taper waveguide and a portion of the slab region in the vicinity of the taper waveguide in a certain distance.

Accordingly, a novel low-loss optical coupling apparatus is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the perspective view showing the first preferred embodiment according to the present invention;

FIG. 2 is the front view showing the first preferred embodiment;

FIG. 3 is the front view showing the channel waveguide of the first preferred embodiment;

FIG. 4 is the perspective view showing the second preferred embodiment;

FIG. 5 is the front view showing the second preferred embodiment;

FIG. 6A is the side view and the optical field coupling for the first preferred embodiments;

FIG. 6B is the side view and the optical field coupling for the second preferred embodiments;

FIG. 7 is the perspective view showing the third preferred embodiment;

FIG. 8 is the front view showing the third preferred embodiment;

FIG. 9 is the front view showing the channel waveguide of the third preferred embodiment;

FIG. 10 is the perspective view showing the fourth preferred embodiment;

FIG. 11 is the front view showing the fourth preferred embodiment;

FIG. 12A is the side view and the optical field coupling for the third preferred embodiments;

FIG. 12B is the side view and the optical field coupling for the fourth preferred embodiments;

FIG. 13 is the perspective view showing the fifth preferred embodiment; and

FIG. 14 is the perspective view showing the sixth preferred embodiment.

### DESCRIPTION OF THE PREFERRED EMBODIMENTS

The following descriptions of the preferred embodiments are provided to understand the features and the structures of the present invention.

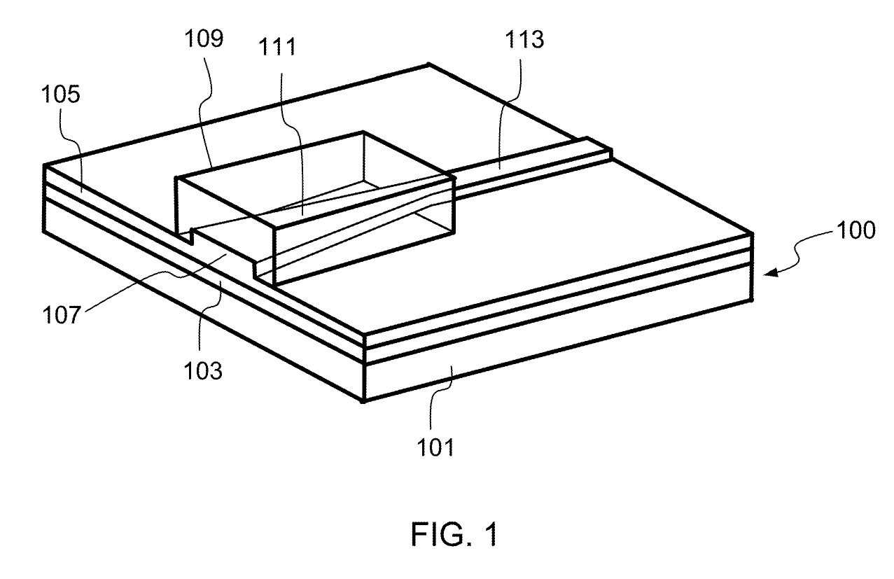

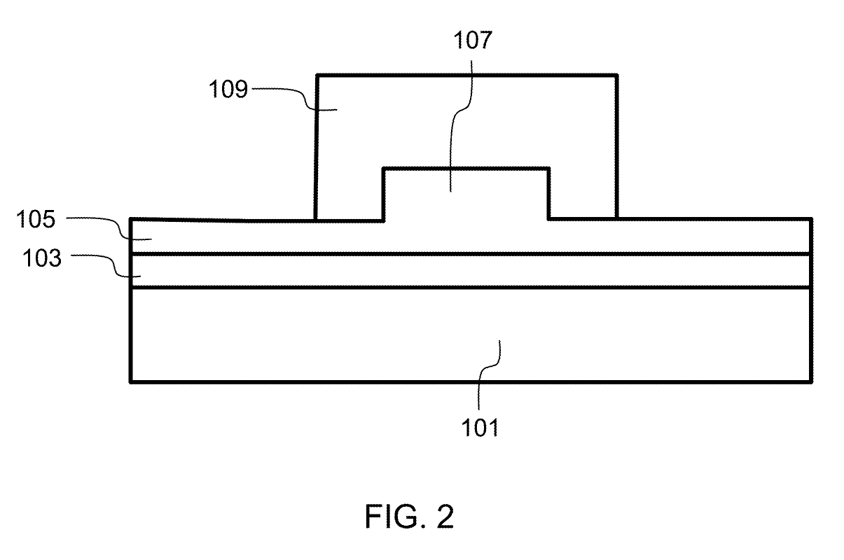

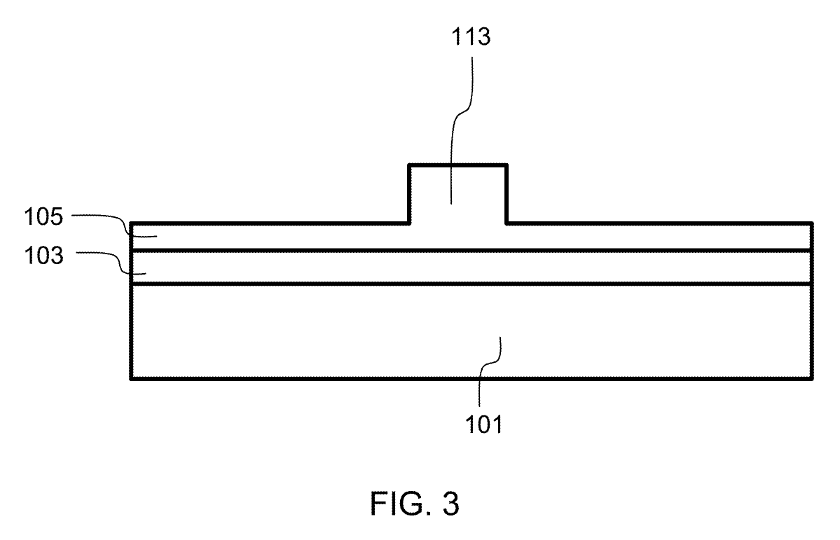

Please refer to FIG. 1 to FIG. 3, which are a perspective view showing a first preferred embodiment according to the present invention; a front view showing the first preferred embodiment; and a front view showing the channel waveguide of the first preferred embodiment. As shown in the figures, the present invention is a low-loss optical coupling apparatus, comprising a silicon-on-insulator wafer 100, a silicon dioxide layer 103, a channel waveguide 113, a taper waveguide 111 and a thick-film silicon dioxide layer 109. On the taper waveguide 111, a thick-film silicon dioxide layer 109 is added. The width of the taper waveguide 111 and the total thickness of the thick-film silicon dioxide layer 109 and the waveguide layer 107 are coordinated with a diameter of an optical field to match optical mode sizes of an optical fiber and the chip for reducing optical loss.

The silicon-on-insulator wafer 100 has a silicon substrate 101. The silicon dioxide layer 103 is embedded on an upper face of the silicon substrate 101. The taper waveguide 111 is formed on the silicon dioxide layer 103. The taper waveguide 111 is a ridge waveguide, comprising a slab region 105 and a waveguide region 107. The taper waveguide has an end in flush with an end of the thick-film silicon dioxide layer. In addition, an end of the waveguide region 107 is connected to an end of the chip to increase a horizontal dimension of the taper waveguide 111 for fitting the fiber. Another end of the taper waveguide 111 is tapered to fit a width of a single channel mode waveguide and is connected to an end of the channel waveguide 113. The thick-film silicon dioxide layer 109 is formed on the waveguide region 107 to increase a vertical dimension of the waveguide region 107 to fit the fiber to reducing mismatch with the optical field.

The thick-film silicon dioxide layer 109 is fabricated on the waveguide region 107 of the taper waveguide 111 to form a large area of optical confinement at a front end of the chip to match the mode size of the silicon waveguide of the chip with the optical field size of the optical fiber. By the large-area of optical confinement at the front end of the optical field, most light is confined and leakage is thus prevented. Finally, the optical field is eventually coupled to the channel waveguide 113, thus considerably reducing optical loss.

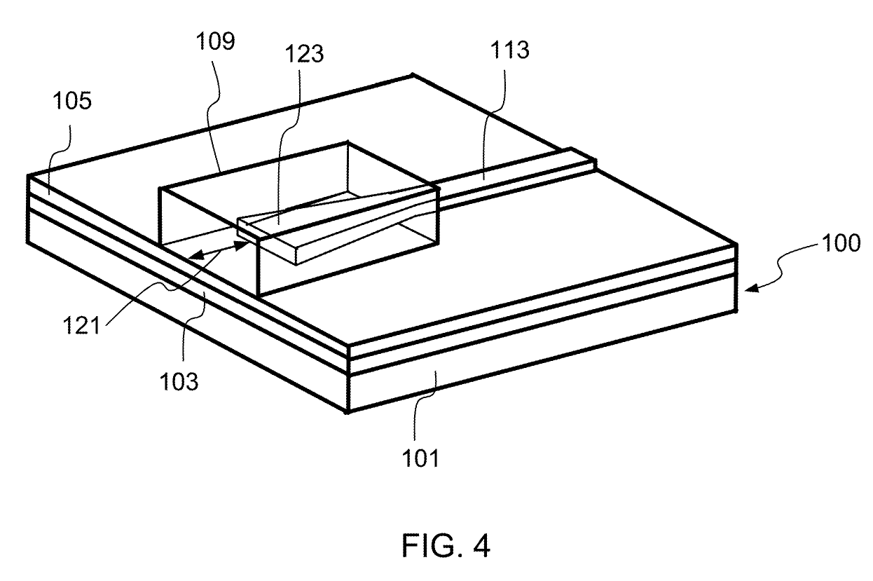

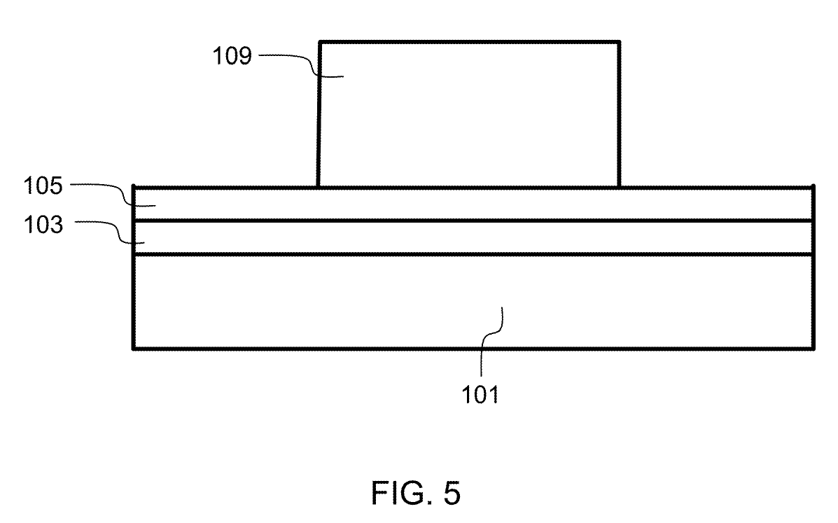

Please refer to FIG. 4 and FIG. 5, which are a perspective view and a front view showing a second preferred embodiment. As shown in the figures, a second preferred embodiment has an indented taper waveguide 123. Compared with a waveguide region 107 as shown in FIG. 1, the indented taper waveguide 123 is inner shifted for a distance 121 to increase the size of the optical field, thus reducing the optical loss. That is, the indented taper waveguide 123 is completely covered by the thick-film silicon dioxide layer 109.

As the taper waveguide 123 is indented, the large area of optical confinement is formed by the thick-film silicon dioxide layer 109 and the slab region 105.

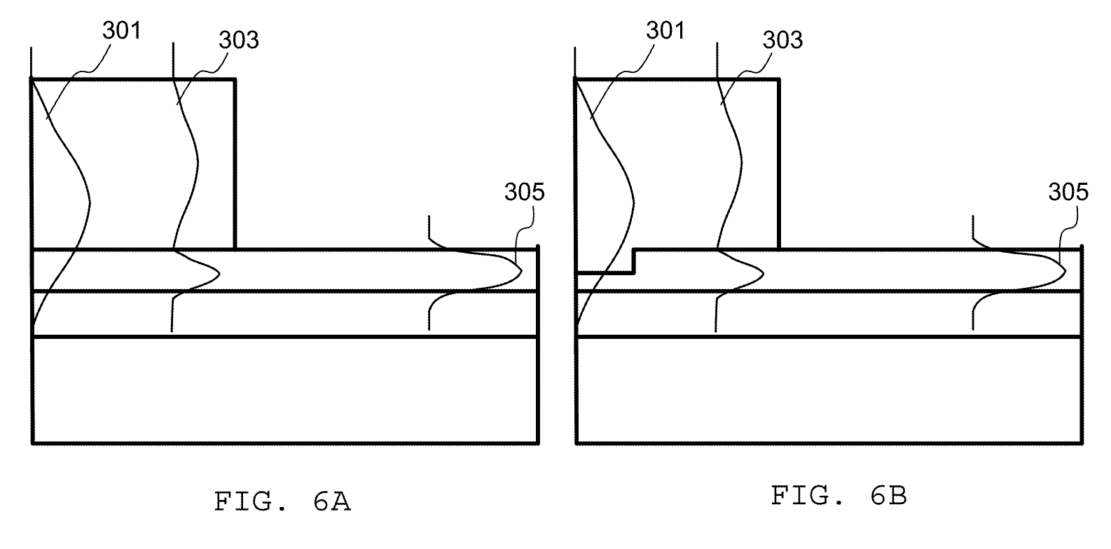

Please refer to FIGS. 6A and 6B, which are the side view and the optical field coupling for the first and second preferred embodiments. As shown in the figure, at a front end of a chip, an optical field distribution is shown by a first curve 301. After optical coupling, optical field of an input light is eventually coupled, whose distribution is shown as a second curve 303, to the channel waveguide 113. Finally, the light is completely coupled to a channel waveguide 113 and is distributed as shown by a third curve 305.

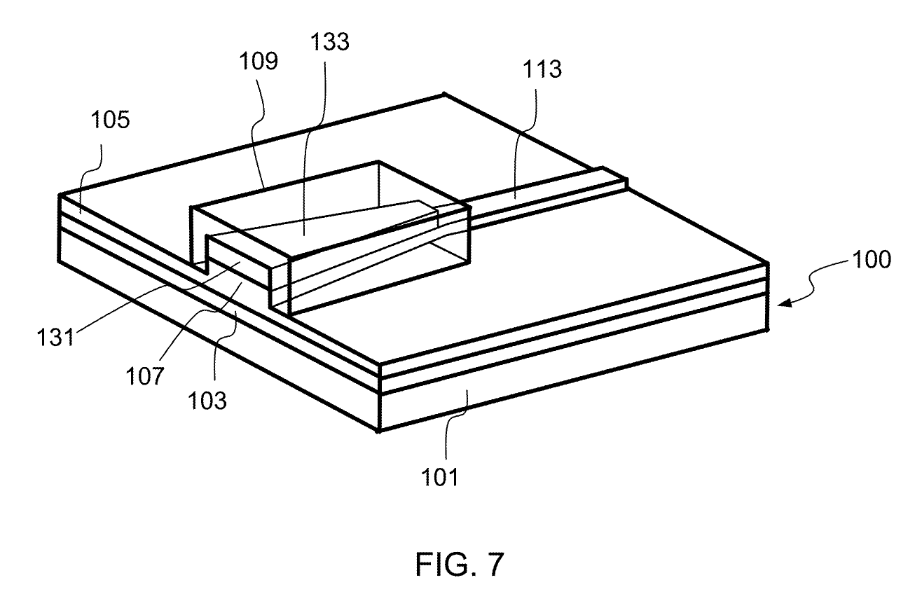

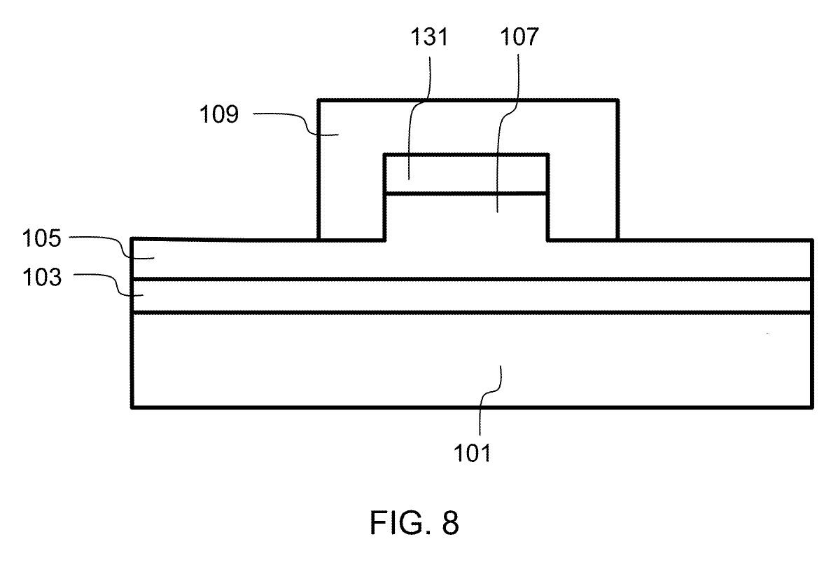

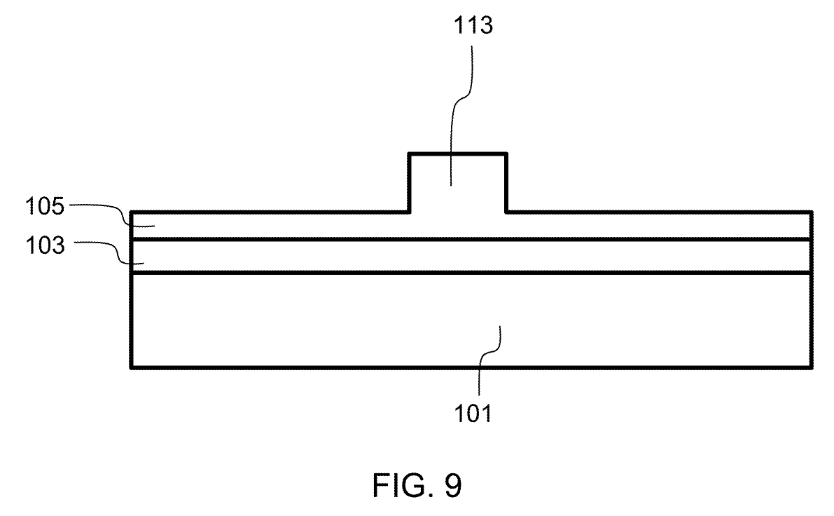

Please refer to FIG. 7 to FIG. 9, which are a perspective view and a front view showing the third preferred embodiment; and a front view showing the channel waveguide of the third preferred embodiment. As shown in the figures, the third preferred embodiment has a taper waveguide 133 having a polymer layer 131 on a waveguide region 107. The polymer layer 131 is a layer made of silicon nitride, photo resist or any polymer. A thick-film silicon dioxide layer 109 is formed on the polymer layer 131. Thus, the taper waveguide 133 having the polymer layer 131 (silicon nitride, photo resist or polymer) is formed. By a gradient change of refractive index, the optical coupling efficiency is improved.

Since the thick-film silicon dioxide layer 109 is formed on the taper waveguide 133, which has the polymer layer 131 on the waveguide region 107. A large area of optical confinement is formed at a front end of a chip to match a mode size of a waveguide of the chip with an optical field size of an optical fiber. Moreover, by a gradient change of the refractive index, coupling efficiency is increased. By the large area of optical confinement at the front end of the chip, most light is confined to prevent optical leakage. The optical field is eventually coupled to a channel waveguide 113, thus considerably reducing optical loss.

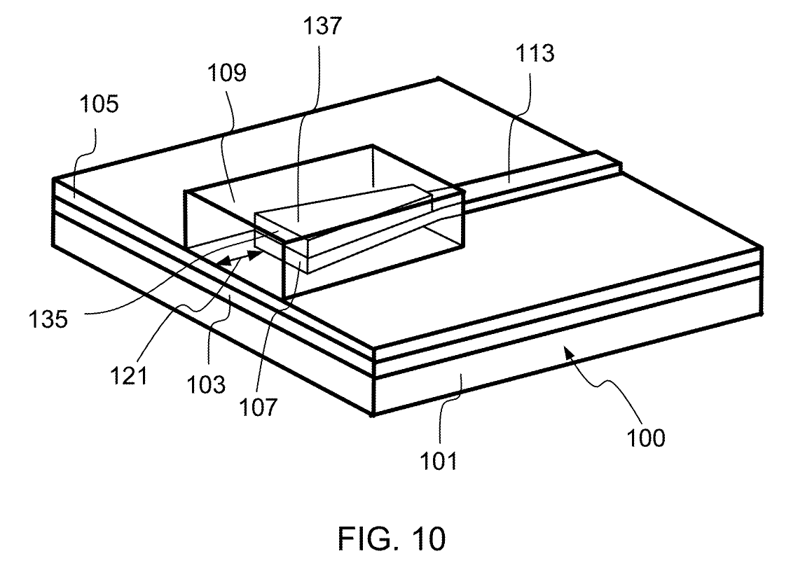

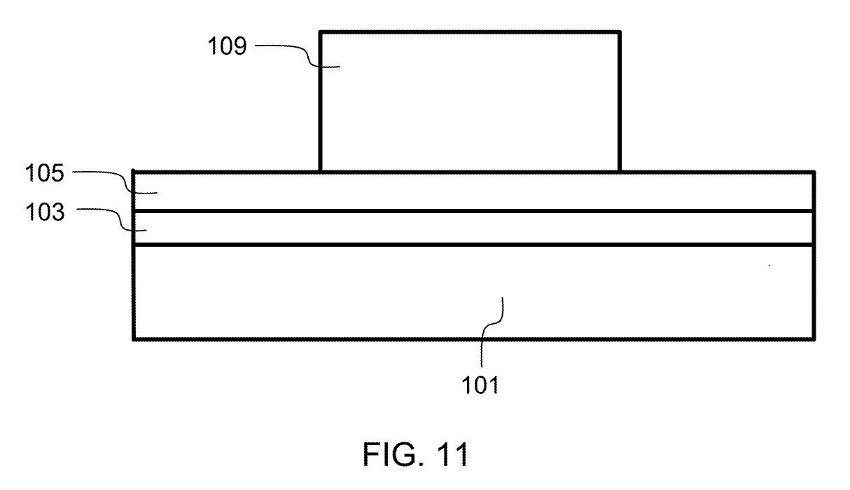

Please refer to FIG. 10 and FIG. 11, which are a perspective view and a front view showing a fourth preferred embodiment. As shown in the figures, the fourth preferred embodiment has an indented taper waveguide 137 having a polymer layer 135 formed on a waveguide region 107. The polymer layer 131 is made of silicon nitride, photo resist or a polymer. Hence, the optical coupling efficiency and the mode size are increased, thus reducing the optical loss.

Because the taper waveguide 137 is indented, a large area of optical confinement is formed by a thick-film silicon dioxide layer 109 and a slab region 105. Light is transmitted through the taper waveguide 137 that is indented and has the polymer layer 135 made of silicon nitride, photo-resist or polymer. By a gradient change of refractive index, coupling efficiency is increased, and the large area of optical confinement is formed, thus reducing the optical coupling loss.

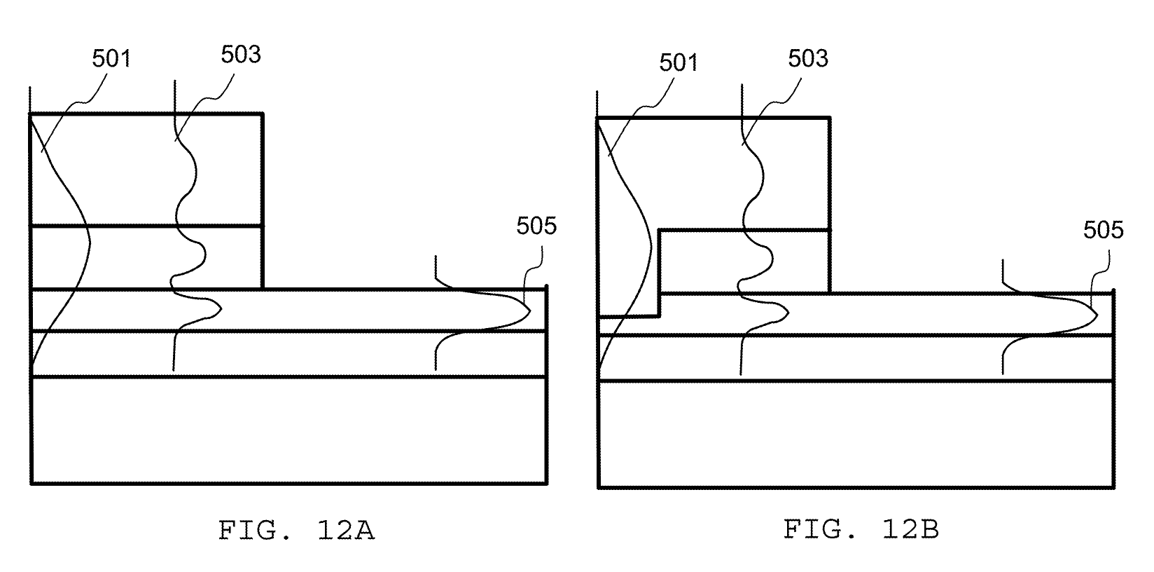

Please refer to FIGS. 12A and 12B, which are the side view and the optical field coupling for the third and fourth preferred embodiment. As shown in figure, at a front end of a chip, an optical field distribution is shown by a fourth curve 501. After optical coupling, the optical field of input light is eventually coupled, whose distribution is shown as a fifth curve 503, to the channel waveguide 113. Finally, light is completely coupled to the channel waveguide 113 and is distributed to form a single mode optical field with a high-coupling efficiency as shown by a sixth curve 505.

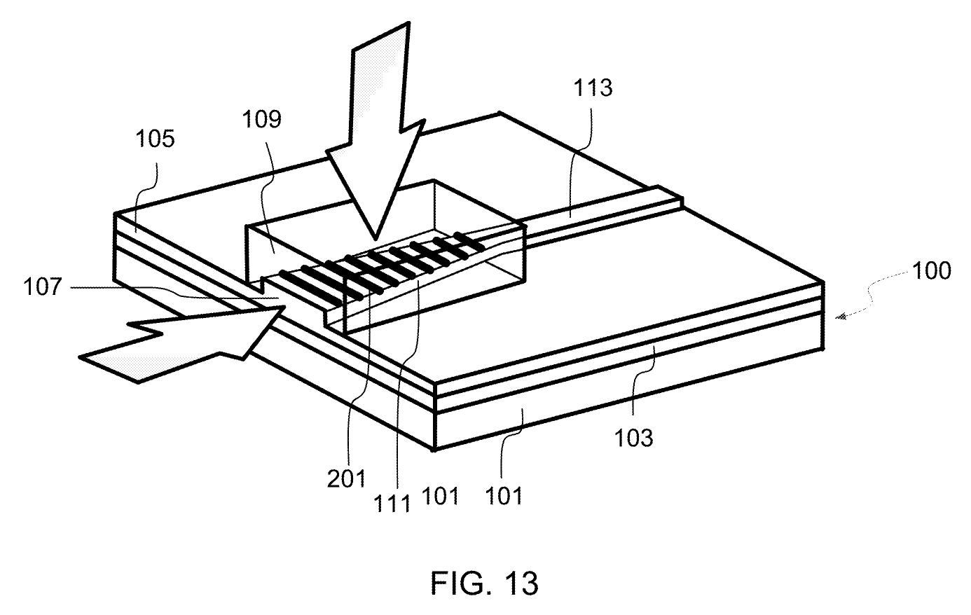

Please refer to FIG. 13, which is a perspective view showing a fifth preferred embodiment. As shown in the figure, the fifth preferred embodiment has a grating 201 formed on the taper waveguide 111 so that an optical field that is perpendicular to a chip can be also coupled to a channel waveguide 113. Thus, both an optical field perpendicular to the chip and an optical field parallel to the chip can be coupled to a sub-micrometer channel waveguide 113 with low loss.

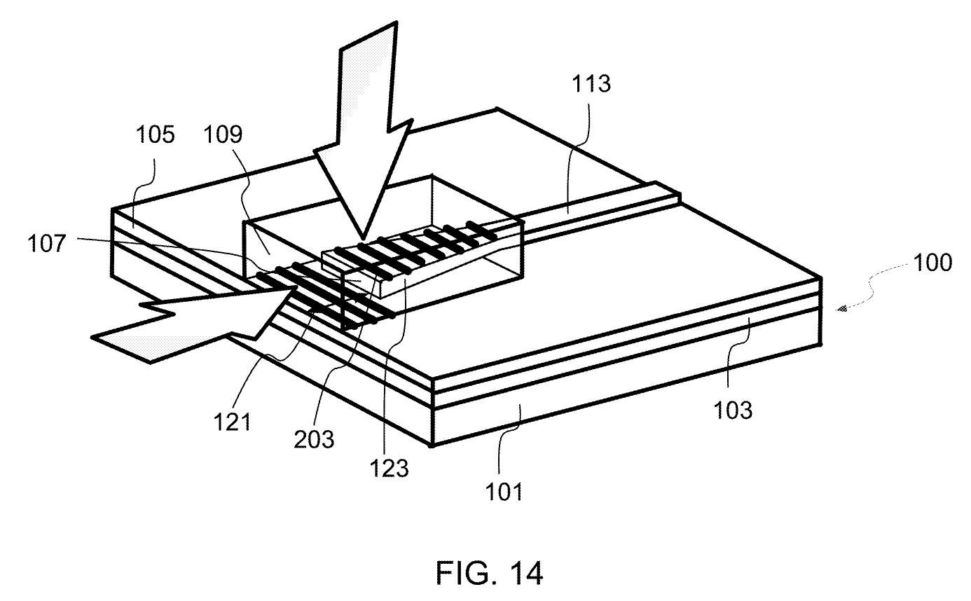

Please refer to FIG. 14, which is a perspective view showing a sixth preferred embodiment. As shown in the figure, a sixth preferred embodiment has a grating 203 formed on an indented taper waveguide 123 and on a portion of a slab region 105 in a vicinity of the indented taper waveguide 123 in a distance 121. Thus, both an optical field perpendicular to the chip and the optical field parallel to the chip can be coupled to a sub-micrometer channel waveguide 113 with low loss.

Thus, a thick-film silicon dioxide layer is formed on a taper waveguide to confine light in the thick-film dioxide layer, thus preventing the light from leaking into air. An optical field confined in the thick-film silicon dioxide layer is eventually coupled to a channel waveguide that has a high refractive index to prevent the light from leaking into air, thus reducing optical loss. In this way, width of the taper waveguide (horizontal direction) and total thickness of the thick-film silicon dioxide layer (vertical direction) are determined corresponding to a diameter of the optical field to match the optical mode of an optical fiber with that of a chip, thus reducing optical loss.

Furthermore, by using silicon nitride, photoresist or a polymer, by being coordinated with a grating, by indenting the taper waveguide region, six preferred embodiments according to the present invention are provided for optical coupling perpendicular and/or parallel to the surface of a chip. Thus, the present invention has a small size, a simple structure and full functions for not only improving coupling efficiency but also preventing high loss between sub-micron silicon waveguide and fiber.

To sum up, the present invention is a low-loss optical coupling apparatus, where sub-micron width waveguide and 2 micron fiber are used for optical coupling to be used in optical interconnection between chips.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A low-loss optical coupling apparatus, comprising a silicon-on-insulator wafer 100, said silicon-on-insulator wafer 100 having a silicon substrate 101;
a silicon dioxide layer 103, said silicon dioxide layer 103 being located on the silicon substrate 101;
a waveguide layer, said waveguide layer being located on the silicon dioxide layer 103.
a waveguide circuit, said waveguide circuit being located on said waveguide layer which comprises a slab region and a waveguide region;
a taper waveguide 111, said taper waveguide 111 being a waveguide circuit which has one larger-width end and one smaller-width end, said larger-width end being connected to an end of the chip;
a channel waveguide 113, said channel waveguide 113 being a waveguide circuit connected to said smaller-width end of said taper waveguide 111; and
a thick-film silicon dioxide layer 109, said thick-film silicon dioxide layer 109 being located on said taper waveguide 111.

2. The apparatus according to claim 1,
wherein said channel waveguide 113 is a single-mode channel optical waveguide.

3. The apparatus according to claim 1,
wherein said taper waveguide 111 has an end in flush with an end of said thick-film silicon dioxide layer 109.

4. The apparatus according to claim 3,
wherein said apparatus further comprises a polymer layer 131 located on said taper waveguide 111.

5. The apparatus according to claim 4,
wherein said polymer layer 131 is made of a material selected from a group consisting of silicon nitride, photo-resist and a polymer.

6. The apparatus according to claim 3,
wherein said apparatus further comprises a grating 201 located on said taper waveguide 111.

7. The apparatus according to claim 1,
wherein said taper waveguide 123 is indented and is completely covered by said thick-film silicon dioxide layer 109.

8. The apparatus according to claim 7,
wherein said apparatus further comprises a polymer layer 135 located on said indented taper waveguide 123.

9. The apparatus according to claim 8,
wherein said polymer layer 135 is made of a material selected from a group consisting of silicon nitride, photo-resist and a polymer.

10. The apparatus according to claim 7,
wherein said apparatus further comprises a grating 201 located on said indented taper waveguide 123;
and a portion of said slab region 105 in a vicinity of said indented taper waveguide 123 in a distance 121.
